(19) United States
(12) Patent Application Publication
(10) Pub. No.: US 2008/0278082 A1
(43) Pub. Date: Nov. 13, 2008

(54) PLASMA DISPLAY DEVICE AND METHOD FOR DRIVING THE SAME

(76) Inventors: HIDEAKI OHKI, Tokyo (JP); Makoto Onozawa, Yokohama (JP); Masahisa Tsukahara, Fujisawa (JP); Hisafumi Imura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/830,882

(22) Filed: Jul. 31, 2007

(30) Foreign Application Priority Data
Jan. 26, 2007 (JP) 2007-016609

(51) Int. Cl. G09G 3/28

(52) U.S. Cl. 315/169.1

(57) ABSTRACT

There is provided a method for driving a plasma display device characterized by including a first step of turning off first and fourth switching devices and turning on second and third switching devices, a second step of turning on the first switching device and turning off the second to the fourth switching devices after the first step and a third step of turning on the first and the fourth switching devices and turning off the second and the third switching devices after the second step.

### CROSS-REFERENCE TO RELATED APPLICATIONS

This application is based upon and claims the benefit of priority from the prior Japanese Patent Application No. 2007-016609, filed on Jan. 26, 2007, the entire contents of which are incorporated herein by reference.

### BACKGROUND OF THE INVENTION

1. Field of the Invention

The present invention relates to a plasma display device and a method for driving the same.

2. Description of the Related Art

FIG. 16 is a circuit diagram illustrating a first configurational example of a plasma display device and FIG. 17 is a timing chart illustrating a method for driving the same (refer to the following Patent Document 1). A voltage VXi is a voltage that appears at an electrode Xi, a current IL1 is a current flowing into a coil L1, a voltage VYi is a voltage that appears at an electrode Yi and a current IL2 is a current flowing into a coil L2. A voltage Vxy is a voltage across the electrodes Xi and Yi and is represented by the voltages VXi-VYi.

The electrodes Xi and Yi serve to discharge. A capacitance Cp is a capacitance created between the electrodes Xi and Yi. A driving circuit 4 supplies the voltage VXi to the electrode Xi. A driving circuit 5 supplies the voltage VYi to the electrode Yi.

At a time t1, only voltages LU1 and CD2 are rendered to be in a high level state. This turns on only transistors Slu1 and Ssd2 to cause a current I1 to flow through the terminal of a ground potential GND as illustrated in FIG. 18. The coil current IL1 flows and the voltage VXi increases from 0 V to a positive voltage Vs due to LC resonance between the capacitance Cp and the coil L1.

At a time t2, the voltage LU1 is rendered to be in a low level state and voltage CU1 is rendered to be in a high level state. This turns on only transistors Ssu1 and Ssd2 to cause a current I2 to flow as illustrated in FIG. 19. The voltage VXi is fixed to the voltage Vs. Thereafter, the voltage CU1 is rendered to be in a low level state to turn off the transistor Ssu1.

At a time t3, a voltage LD1 is rendered to be in a high level state. This turns on only transistors Sld1 and Ssd2 to cause a current I3 to flow through the terminal of a ground potential GND as illustrated in FIG. 20. The coil current IL1 flows and the voltage VXi lowers from the voltage Vs to 0 V due to LC resonance between the capacitance Cp and the coil L1.

At a time t4, the voltage LD1 is rendered to be in a low level state and the voltages CD1 and CD2 are rendered to be in a high level state. This turns on a transistor Ssd1 to cause a current I4 to flow as illustrated in FIG. 21. The voltage VXi is fixed to 0 V.

After that, the voltage LU2 is rendered in a high level state. This turns on only transistors Ssd1 and Slu2 to cause a current I5 to flow through the terminal of a ground potential GND as illustrated in FIG. 22. The coil current IL2 flows and the voltage VYi increases from 0 V to the voltage Vs due to LC resonance between the capacitance Cp and the coil L2.

At a time t5, a voltage LU2 is rendered to be in a low level state and a voltage CU2 is rendered to be in a high level state. This turns on a transistor Ssu2 to cause a current I6 to flow as illustrated in FIG. 23. The voltage VYi is fixed to the voltage Vs. Thereafter, the voltage CU2 is rendered to be in a low level state to turn off the transistor Ssu2.

At a time t6, a voltage LD2 is rendered to be in a high level state. This turns on only transistors Ssd1 and Sld2 to cause a current I7 to flow through the terminal of a ground potential GND as illustrated in FIG. 24. The coil current IL2 flows and the voltage VYi lowers from the voltage Vs to 0 V due to LC resonance between the capacitance Cp and the coil L2.

After that, the voltages CD1 and LD2 are rendered to be in a low level state and the voltage CD2 is rendered to be in a high level state. This turns on a transistor Ssd2 to cause a current I8 to flow as illustrated in FIG. 25. The voltage VYi is fixed to 0 V. Thereafter, returning to a time t1, the operation of a period TT is repeated.

As described above, an LC resonance circuit is formed of a series resonance circuit including the capacitance Cp and the coil L1 or L2. The plasma display device needs the transistors Slu1, Sld1, Slu2 and Sld2 for starting a series resonance and the capacitances C1 and C2 for transferring the charge of the capacitance Cp, which leads to a drawback in that circuit elements are increased in number.

In addition, a pause period during which the voltage Vxy becomes 0 V is required between the LC resonance at the voltage VXi and that at the voltage VYi, which raises a drawback in that the period TT is increased.

Furthermore, a drawback is occurred in that switching for the LC resonance needs to be performed as many as four times in one period TT.

FIG. 26 is a circuit diagram illustrating a second configurational example of a plasma display device and FIG. 27 is a timing chart illustrating a method for driving the same (refer to the following Patent Document 2). A voltage VXi is a voltage that appears at an electrode Xi, a voltage VYi is a voltage that appears at an electrode Yi and a current IL is a current flowing into a coil L. A voltage Vxy is a voltage across the electrodes Xi and Yi and is represented by the voltage VXi-VYi.

The electrodes Xi and Yi serve to discharge. A capacitance Cp is a capacitance created between the electrodes Xi and Yi. A driving circuit 4 supplies the voltage VXi to the electrode Xi. A driving circuit 5 supplies the voltage VYi to the electrode Yi. A charging and discharging circuit unit 2601 includes a coil L and transistors Slu and sld.

Prior to a time t1, the voltages VXi and VYi are set to be 0 V and the voltage Vs respectively. At a time t1, only a voltage LD is rendered to be in a high level state. This turns on only a transistor Sld to cause a coil current IL to flow, the voltage VXi increases from 0 V to the voltage Vs and the voltage VYi lowers from the voltage Vs to 0 V due to LC resonance between the capacitance Cp and the coil L.

At a time t2, voltages CU1 and CD2 are rendered to be in a high level state. This turns on transistors Ssu1 and Ssd2. The voltage VXi is fixed to the voltage Vs and the voltage VYi is fixed to 0 V. Thereafter, the voltage LD is rendered to be in a low level state to turn off the transistor Sld. After that, the voltages CU1 and CD2 are rendered to be in a low level state to turn off the transistors Ssu1 and Ssd2.

At a time t3, a voltage LU is rendered to be in a high level state to turn on the transistor Slu. Then, a coil current IL flows, the voltage VXi lowers from the voltage Vs to 0 V and the voltage VYi increases from 0 V to the voltage Vs.

At a time t4, voltages CU2 and CD1 are rendered to be in a high level state to turn on transistors Ssu2 and Ssd1. The voltage VXi is fixed to 0 V and the voltage VYi is fixed to the voltage Vs. Thereafter, the voltage LU is rendered to be in a low level state to turn off the transistor Slu. After that, the voltages CU2 and CD1 are rendered in a low level state to turn off the transistors Ssu2 and Ssd1. After that, returning to a time t1, the operation of a period TT is repeated.

As described above, an LC resonance circuit is formed of a parallel resonance circuit including the capacitance Cp and the coil L. The plasma display device needs the transistors Slu and Sld for starting a parallel resonance, which leads to a drawback in that circuit elements are increased in number.

In addition, a drawback is encountered in that the charging and discharging circuit unit 2601 is required including a path into which a resonance current flows between the driving circuits 4 and 5.

The following Patent Document 3 discloses a driving circuit including an energy recovering unit used for a flat panel display.

[Patent Document 1] Japanese Patent Application Laid-Open No. 63-101897

[Patent Document 2] Japanese Patent Application Laid-Open No. 8-152865

[Patent Document 3] Translated National Publication of Patent Application No. 2003-533722

### SUMMARY OF THE INVENTION

The present invention has for its purpose to provide a plasma display device which includes a small number of circuit elements, whose voltage period is short and control is easy and a method for driving the same.

A method for driving a plasma display device according to the present invention is characterized by including: a first and a second discharging electrode; a first coil connected to the first electrode; a second coil connected to the second electrode; a first potential terminal to which a first potential is supplied; a second potential terminal to which a second potential different from the first potential is supplied; first switching means connected between the first electrode and the first potential terminal; second switching means connected between the first electrode and the second potential terminal; third switching means connected between the second electrode and the first potential terminal; fourth switching means connected between the second electrode and the second potential terminal; a first diode connected between the first electrode through the first coil and the first potential terminal; a second diode connected between the first electrode through the first coil and the second potential terminal; a third diode connected between the second electrode through the second coil and the first potential terminal; and a fourth diode connected between the second electrode through the second coil and the second potential terminal; the method including: a first step of turning off the first and fourth switching means and turning on the second and the third switching means; a second step of turning on the first switching means and turning off the second to the fourth switching means after the first step; and a third step of turning on the first and the fourth switching means and turning off the second and the third switching means after the second step.

A plasma display device according to the present invention is characterized by including: a first and a second discharging electrode; a first coil connected to the first electrode; a second coil connected to the second electrode; a first potential terminal to which a first potential is supplied; a second potential terminal to which a second potential different from the first potential is supplied; first switching means connected between the first electrode and the first potential terminal; second switching means connected between the first electrode and the second potential terminal; third switching means connected between the second electrode and the first potential terminal; fourth switching means connected between the second electrode and the second potential terminal; a first diode connected between the first electrode through the first coil and the first potential terminal; a second diode connected between the first electrode through the first coil and the second potential terminal; a third diode connected between the second electrode through the second coil and the first potential terminal; a fourth diode connected between the second electrode through the second coil and the second potential terminal; and a driving circuit performing a first step of turning off the first and fourth switching means and turning on the second and the third switching means, a second step of turning on the first switching means and turning off the second to the fourth switching means after the first step and a third step of turning on the first and the fourth switching means and turning off the second and the third switching means after the second step.

### BRIEF DESCRIPTION OF THE DRAWINGS

FIG. 1 is a diagram illustrating a configurational example of a plasma display device according to a first embodiment of the present invention;

FIG. 2 is an exploded perspective view illustrating a configurational example of the plasma display panel;

FIG. 3 is a diagram illustrating a configurational example of one frame of an image;

FIG. 4 is a circuit diagram illustrating a configurational example of an X and a Y electrode driving circuit and address electrode driving circuit according to the first embodiment;

FIG. 5 is a timing chart illustrating a method for driving the X and the Y electrode driving circuit in FIG. 4;

FIG. 6 is a diagram illustrating a current flowing into the circuit in FIG. 4;

FIG. 7 is a diagram illustrating a current flowing into the circuit in FIG. 4;

FIG. 8 is a diagram illustrating a current flowing into the circuit in FIG. 4;

FIG. 9 is a diagram illustrating a current flowing into the circuit in FIG. 4;

FIG. 10 is a circuit diagram illustrating a configurational example of an X and a Y electrode driving circuit and address electrode driving circuit according to a second embodiment of the present invention;

FIG. 11 is a timing chart illustrating a method for driving the X and the Y electrode driving circuit in FIG. 10;

FIG. 12 is a diagram illustrating a current flowing into the circuit in FIG. 10;

FIG. 13 is a diagram illustrating a current flowing into the circuit in FIG. 10;

FIG. 14 is a diagram illustrating a current flowing into the circuit in FIG. 10;

FIG. 15 is a diagram illustrating a current flowing into the circuit in FIG. 10;

FIG. 16 is a circuit diagram illustrating a first configurational example of a plasma display device;

FIG. 17 is a timing chart illustrating a method for driving the circuit in FIG. 16;

FIG. 18 is a diagram illustrating a current flowing into the circuit in FIG. 16;

FIG. 19 is a diagram illustrating a current flowing into the circuit in FIG. 16;

FIG. 20 is a diagram illustrating a current flowing into the circuit in FIG. 16;

FIG. 21 is a diagram illustrating a current flowing into the circuit in FIG. 16;

FIG. 22 is a diagram illustrating a current flowing into the circuit in FIG. 16;

FIG. 23 is a diagram illustrating a current flowing into the circuit in FIG. 16;

FIG. 24 is a diagram illustrating a current flowing into the circuit in FIG. 16;

FIG. 25 is a diagram illustrating a current flowing into the circuit in FIG. 16;

FIG. 26 is a circuit diagram illustrating a second configurational example of a plasma display device; and

FIG. 27 is a timing chart illustrating a method for driving the circuit in FIG. 26.

### DETAILED DESCRIPTION OF THE PREFERRED EMBODIMENTS

### First Embodiment

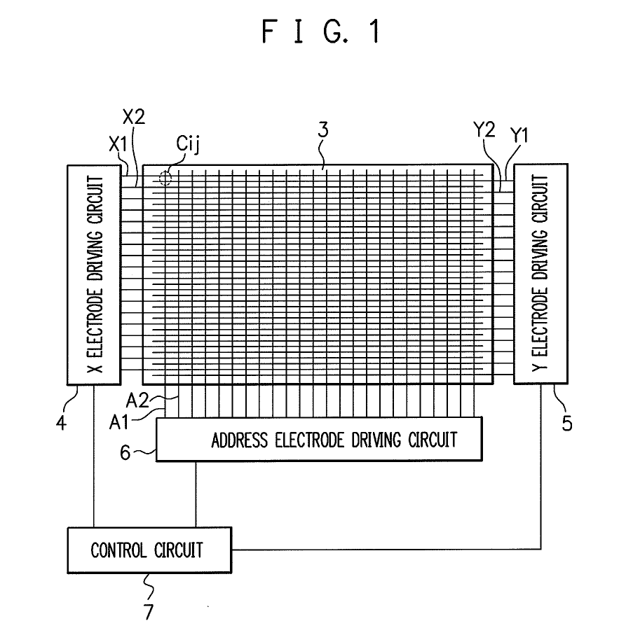

FIG. 1 is a diagram illustrating a configurational example of a plasma display device according to a first embodiment of the present invention. A control circuit 7 controls an X electrode driving circuit 4, Y electrode driving circuit 5 and address electrode driving circuit 6. The X electrode driving circuit 4 supplies a prescribed voltage to a plurality of X electrodes X1, X2, . . . . Each of the X electrodes X1, X2, . . . or a generic name thereof is referred to as “X electrode Xi,” where “i” means a subscript. The Y electrode driving circuit 5 supplies a prescribed voltage to a plurality of Y (scanning) electrodes Y1, Y2 . . . . Each of the Y electrodes X1, X2, . . . or a generic name thereof is referred to as “Y electrode Yi,” where “i” means a subscript. The address electrode driving circuit 6 supplies a prescribed voltage to a plurality of address electrodes A1, A2, . . . . Each of the address electrodes A1, A2, . . . or a generic name thereof is referred to as “address electrode Aj,” where “j” means a subscript.

In the plasma display panel 3, the Y electrode Yi and the X electrode Xi form rows extending horizontally and in parallel and the address electrode Aj forms columns extending vertically. The Y electrode Yi and the X electrode Xi are alternately arranged in the vertical direction. The Y electrode Yi and the address electrode Aj form a two-dimensional matrix with row i and column j. A display cell Cij is formed of an intersection of the Y electrode Yi and address electrode Aj and the X electrode Xi adjacent and corresponding thereto. The display cell Cij corresponds to a pixel, thereby enabling the plasma display panel 3 to display a two-dimensional image.

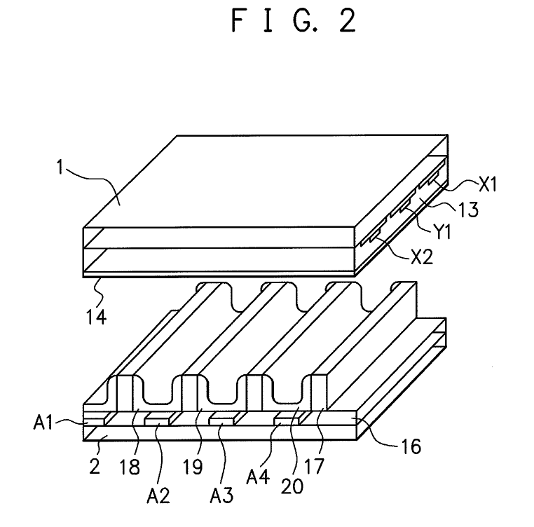

FIG. 2 is an exploded perspective view illustrating a configurational example of the plasma display panel 3. The X electrode Xi and Y electrode Yi are formed on a whole glass substrate 1, which are coated with a dielectric layer 13 to insulate the electrodes from discharge space. Furthermore, a MgO (magnesium oxide) protective layer 14 coats the dielectric layer 13. On the other hand, the address electrode Aj is formed on a rear surface glass substrate 2 arranged opposite to the whole glass substrate 1 and the address electrode Aj is coated with a dielectric layer 16. Furthermore, phosphors 18 to 20 coat the dielectric layer 16. Red, blue and green phosphors 18 to 20 are arranged and coated in a strip shape for each of colors on the inside surface of barrier ribs 17. Electrical discharge between the X electrode Xi and the Y electrode Yi excites the phosphors 18 to 20 to emit each color. The discharge space between the whole glass substrate 1 and the rear surface glass substrate 2 is filled with Ne+Xe Penning gas.

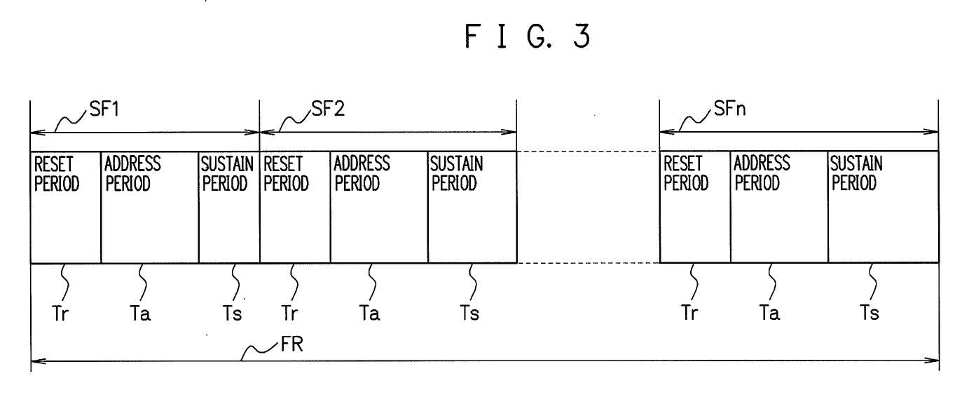

FIG. 3 is a diagram illustrating a configurational example of one frame FR of an image. An image is formed at a rate of 60 frames/second, for example. One frame FR of an image is formed of a first sub-frame SF1, a second sub-frame SF2, . . . and an n-th sub-frame SFn. The “n” is 10, for example, and corresponds to gradation bit number. Hereinafter, each of the sub-frames SF1, SF2, . . . or a generic name thereof is referred to as “sub-frame SF.”

Each sub-frame SF is formed of a reset period Tr, address period Ta and sustain (sustaining discharge) time period Ts. During the reset period Tr, a predetermined voltage is applied to the X electrode Xi and the Y electrode Yi to initialize the display cell Cij.

In the address period Ta, the light emission or non-light emission of each display cell Cij can be selected by address discharge between the address electrode Aj and the Y electrode Yi. Specifically, in the address period Ta, scan pulses are sequentially scanned and applied to the Y electrodes Y1, Y2, . . . and address pulses corresponding to the scan pulses are applied to the address electrode Aj to select display pixels. If address pulses of the address electrode Aj are generated correspondingly to the scan pulses of the Y electrode Yi, the display cell Cij of the Y electrode Yi and the X electrode Xi are selected. If address pulses of the address electrode Aj are not generated correspondingly to the scan pulses of the Y electrode Yi, the display cell Cij of the Y electrode Yi and the X electrode Xi are not selected. If the address pulses are generated correspondingly to the scan pulses, an address discharge is generated between the address electrode Aj and the Y electrode Yi, triggering electrical discharge between the X electrode Xi and the Y electrode Yi, storing negative electric charges in the X electrode Xi and positive electric charges in the Y electrode Yi.

In the sustain period Ts, sustain pulses are applied across the X electrode Xi and the Y electrode Yi to cause sustain discharge between the X electrode Xi and the Y electrode Yi of the selected display cell Cij to emit light. The number of times of light emission (length of sustain period Ts) caused by sustain pulses applied across the X electrode Xi and the Y electrode Yi varies with each sub-frame SF. This permits gradation to be determined.

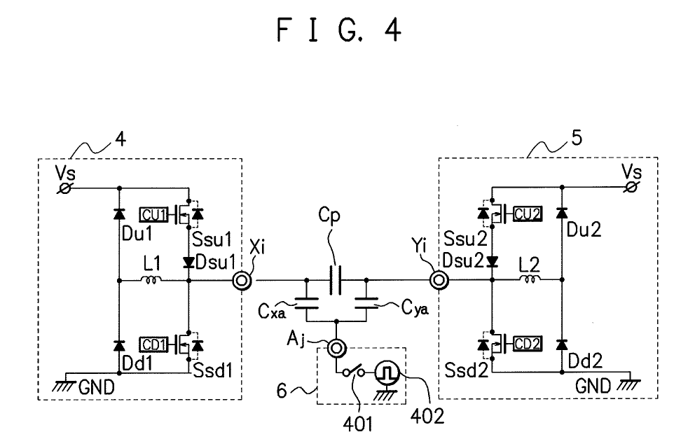

FIG. 4 is a circuit diagram illustrating a configurational example of the X electrode driving circuit 4, Y electrode driving circuit 5 and address electrode driving circuit 6 according to the present embodiment. The X electrode Xi and the Y electrode Yi are discharging electrodes. The capacitance Cp is a panel capacitor disposed between the X electrode Xi and the Y electrode Yi. A capacitance Cxa is a panel capacitor disposed between the X electrode Xi and the address electrode Aj. A capacitance Cya is a panel capacitor disposed between the Y electrode Yi and the address electrode Aj. A ground terminal is a terminal to which a ground potential GND is supplied. A power supply voltage terminal is a terminal to which a power supply voltage Vs is supplied. The power supply voltage Vs is a positive voltage higher than the ground potential GND.

The configuration of the X electrode driving circuit 4 is described below. A coil L1 is connected to the X electrode Xi. A diode Du1 is connected between the X electrode Xi through the coil L1 and the terminal of the power supply voltage Vs. Specifically, the anode of the diode Du1 is connected to the X electrode Xi through the coil L1 and the cathode thereof is connected to the terminal of the power supply voltage Vs. A diode Dd1 is connected between the X electrode Xi through the coil L1 and the terminal of the ground potential GND. Specifically, the cathode of the diode Dd1 is connected to the X electrode Xi through the coil L1 and the anode thereof is connected to the terminal of the ground potential GND.

A series connection circuit of a switching element Ssu1 and a diode Dsu1 forms switching means and is connected between the X electrode Xi and the terminal of the power supply voltage Vs. The switching element Ssu1 is, for example, an n-channel field effect transistor. The transistor Ssu1 includes a parasitic diode, the gate of the transistor Ssu1 is connected to a voltage CU1, the source thereof is connected to the side of the X electrode Xi and the drain thereof is connected to the side of terminal of the power supply voltage Vs. The anode of the parasitic diode is connected to the source of the transistor Ssu1 and the cathode thereof is connected to the drain of the transistor Ssu1. The anode of the diode Dsu1 is connected to the side of terminal of the power supply voltage Vs and the cathode thereof is connected to the side of the X electrode Xi.

A switching element Ssd1 forms switching means and is connected between the X electrode Xi and the terminal of the ground potential GND. The switching element Ssd1 is, for example, an n-channel field effect transistor. The transistor Ssd1 includes a parasitic diode, the gate of the transistor Ssd1 is connected to a voltage CD1, the drain thereof is connected to the X electrode Xi and the source thereof is connected to the terminal of the ground potential GND. The anode of the parasitic diode is connected to the source of the transistor Ssd1 and the cathode thereof is connected to the drain of the transistor Ssd1.

The configuration of the Y electrode driving circuit 5 is described below. A coil L2 is connected to the Y electrode Yi. A diode Du2 is connected between the Y electrode Yi through the coil L2 and the terminal of the power supply voltage Vs. Specifically, the anode of the diode Du2 is connected to the Y electrode Yi through the coil L2 and the cathode thereof is connected to the terminal of the power supply voltage Vs. A diode Dd2 is connected between the Y electrode Yi through the coil L2 and the terminal of the ground potential GND. Specifically, the cathode of the diode Dd2 is connected to the Y electrode Yi through the coil L2 and the anode thereof is connected to the terminal of the ground potential GND.

A series connection circuit of a switching element Ssu2 and a diode Dsu2 forms switching means and is connected between the Y electrode Yi and the terminal of the power supply voltage Vs. The switching element Ssu2 is, for example, an n-channel field effect transistor. The transistor Ssu2 includes a parasitic diode, the gate of the transistor Ssu2 is connected to a voltage CU2, the source thereof is connected to the side of the Y electrode Yi and the drain thereof is connected to the side of terminal of the power supply voltage Vs. The anode of the parasitic diode is connected to the source of the transistor Ssu2 and the cathode thereof is connected to the drain of the transistor Ssu2. The anode of the diode Dsu2 is connected to the side of terminal of the power supply voltage Vs and the cathode thereof is connected to the side of the Y electrode Yi.

A switching element Ssd2 forms switching means and is connected between the Y electrode Yi and the terminal of the ground potential GND. The switching element Ssd2 is, for example, an n-channel field effect transistor. The transistor Ssd2 includes a parasitic diode, the gate of the transistor Ssd2 is connected to a voltage CD2, the drain thereof is connected to the Y electrode Yi and the source thereof is connected to the terminal of the ground potential GND. The anode of the parasitic diode is connected to the source of the transistor Ssd2 and the cathode thereof is connected to the drain of the transistor Ssd2.

FIG. 5 is a timing chart illustrating a method for driving the X and the Y electrode driving circuit 4 and 5 in FIG. 4 and describes the operation of the sustain period Ts in FIG. 3. A voltage VXi denotes a voltage that appears at the X electrode Xi. A current IL1 indicates a current flowing into the coil L1. A voltage VYi denotes a voltage that appears at the Y electrode Yi. A current IL2 indicates a current flowing into the coil L2. A voltage Vxy is a voltage across the X electrode Xi and the electrode Yi and is expressed by the voltages VXi-XYi.

Prior to a time t1, the voltage VXi is set to C [V] and the voltage VYi are set to the power supply voltage Vs [V] as described later in detail.

At a time t1, the voltages CU1 and CU2 are rendered to be in a high level state and the voltages CD1 and CD2 are rendered to be in a low level state. This turns on the transistors Ssu1 and Ssu2 and turns off the transistors Ssd1 and Ssd2. As a result, the voltage VXi becomes Vs [V] and the voltage VYi becomes 2×Vs [V].

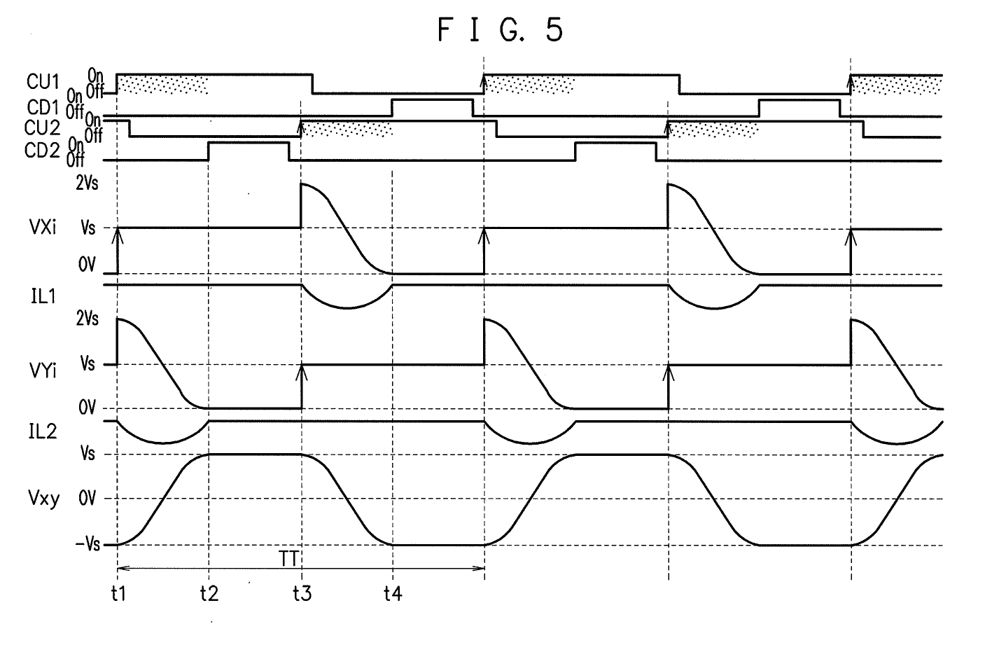

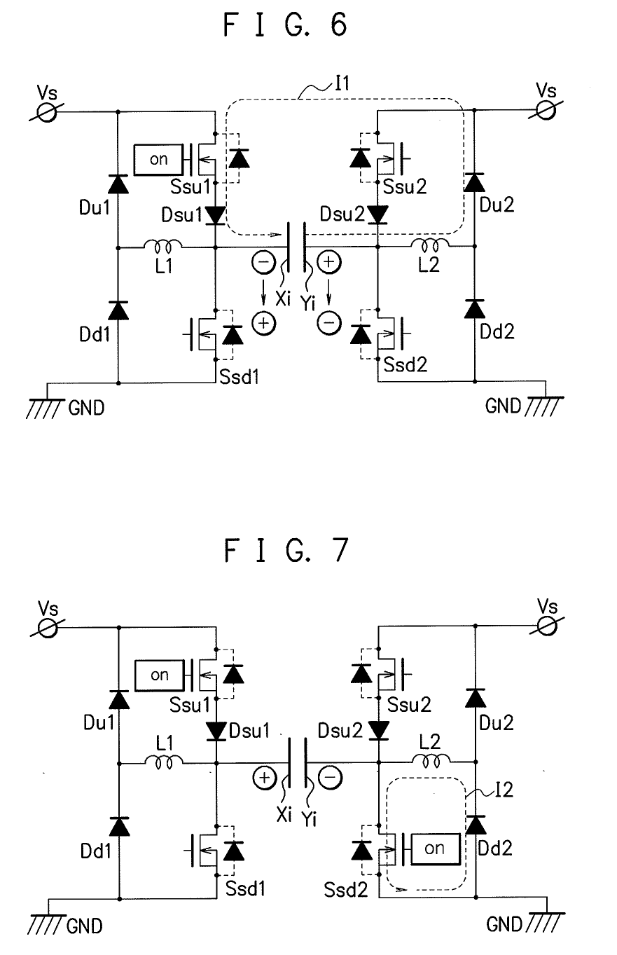

After that, the voltage CU2 is rendered to be in a low level state. Then, the transistor Ssu1 is turned on, the transistors Ssu2, Ssd1 and Ssd2 are turned off and a current I1 flows through the terminal of the power supply voltage Vs as illustrated in FIG. 6. The coil current IL2 flows and the voltage VYi lowers from 2×Vs [V] to 0 [V] due to LC resonance between the capacitance Cp and the coil L2.

At a time t2, the voltage CD2 is rendered to be in a high level state. This turns on the transistors Ssu1 and Ssd2 and turns off the transistors Ssu2 and Ssd1 to cause a current I2 to flow as illustrated in FIG. 7. The voltage VYi is fixed to 0 [V]. Thereafter, the voltage CD2 is rendered to be in a low level state to turn off the transistor Ssd2.

At a time t3, the voltage CU2 is rendered to in a high level state. This turns on the transistors Ssu1 and Ssu2 and turns off the transistors Ssd1 and Ssd2. As a result, the voltage VXi rises to 2×Vs [V] and the voltage VYi increases to Vs [V].

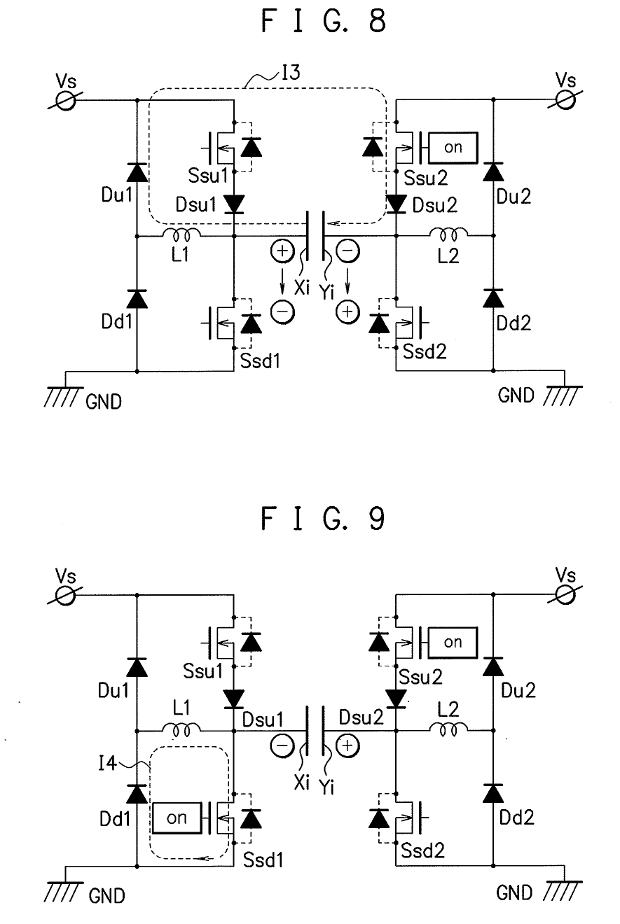

After that, the voltage CU1 is rendered to be in a low level state. This turns on the transistor Ssu2 and turns off the transistors Ssu1, Ssd1 and Ssd2 to cause a current I3 to flow through the terminal of the power supply voltage Vs as illustrated in FIG. 8. The coil current IL1 flows and the voltage VXi lowers from 2×Vs [V] to 0 [V].

At a time t4, the voltage CD1 is rendered to be in a high level state. This turns on the transistors Ssu2 and Ssd1 and turns off the transistors Ssu1 and Ssd2 to cause a current I4 to flow as illustrated in FIG. 9. The voltage VXi is fixed to 0 V. Thereafter, the voltage CD1 is rendered to be in a low level state to turn off the transistor Ssd1.

After that, returning to a time t1, the operation of a period TT is repeated. Electrical discharge is caused between the X electrode Xi and the Y electrode Yi at points when the voltage Vxy increases from 0 [V] to about Vs [V] and decreases from 0 [V] to about −Vs [V].

The address electrode driving circuit 6 is described below. The address electrode driving circuit 6 includes a switch (changing over means) 401 and pulse generating circuit 402. As described above, when address is selected in the address period Ta in FIG. 3, the switch 401 is turned on and the pulse generating circuit 402 supplies address pulses to the address electrode Aj. This causes address discharge between the address electrode Aj and the Y electrode Yi, triggering electrical discharge between the X electrode Xi and the Y electrode Yi, storing negative electric charges in the X electrode Xi and positive electric charges in the Y electrode Yi. The address electrode Aj is an electrode for discharging to the Y electrode Yi or the X electrode Xi. In the sustain period Ts, the switch 401 is turned off. In other words, the switch 401 causes the address electrode Aj to be electrically higher in resistance (to be opened) than the power supply. This prevents an potential variation of the other Y electrode Yi or X electrode Xi transferred from an potential variation of one X electrode Xi or Y electrode Yi from 0 V to the voltage Vs from decreasing due to voltage division between capacitances Cxa and Cya.

As described above, a first switching means (transistor) Ssu1 is connected between a first electrode (X electrode) Xi and a first potential (power supply voltage) Vs. A second switching means (transistor) Ssd1 is connected between the first electrode Xi and the terminal of a second potential (ground potential) GND. A third switching means (transistor) Ssu2 is connected between a second electrode (Y electrode) Yi and the first potential terminal Vs. A fourth switching means (transistor) Ssd2 is connected between the second electrode Yi and the second potential terminal (ground potential) GND.

At a first step at a time t4, the first switching means (transistor) Ssu1 and the fourth switching means (transistor) Ssd2 are turned off and the second switching means (transistor) Ssd1 and the third switching means (transistor) Ssu2 are turned on. At the first step, the voltage VXi that appears at the first electrode (X electrode) Xi becomes the second potential (ground potential) GND. The voltage VYi that appears at the second electrode (Y electrode) Yi becomes the first potential (power supply voltage) Vs.

At the second step before a time t2 following the first step, the first switching means Ssu1 is turned on, and the second, the third and the fourth switching means Ssd1, Ssu2 and Ssd2 are turned off.

At the second step, the voltage VXi that appears at the first electrode Xi becomes the first potential Vs and the voltage VYi that appears at the second electrode Yi changes by a differential potential Vs between the first potential Vs and the second potential GND and changes to the second potential GND due to LC resonance thereafter.

At the third step at a time t2 following the second step, the first and the fourth switching means Ssu1 and Ssd2 are turned on and the second and the third switching means Ssd1 and Ssu2 are turned off. At the third step, the voltage VXi at the first electrode Xi becomes the first potential Vs and the voltage VYi at the second electrode Yi becomes the second potential GND.

The field effect transistors Ssu1, Ssu2, Ssd1 and Ssd2 have parasitic diodes for the reason of their configuration. On the other hand, an insulated gate bipolar transistor (IGBT) does not have a parasitic diode. In the transistors Ssu1 and Ssu2, current always flows from the drain to source. For this reason, the transistors Ssu1 and Ssu2 do not require parasitic diodes. The IGBT may be used as the transistors Ssu1 and Ssu2 instead of field effect transistors.

As is the case with the transistors Ssu1 and Ssu2, the transistors Ssd1 and Ssd2 do not require parasitic diodes because current always flows from the drain to source therein. The IGBT may be used as the transistors Ssd1 and Ssd2 instead of field effect transistors.

### Second Embodiment

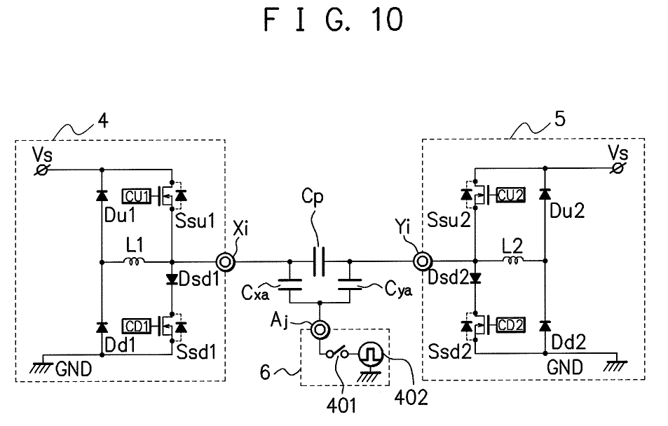

FIG. 10 is a circuit illustrating a configurational example of the X electrode driving circuit 4, the Y electrode driving circuit 5 and the address electrode driving circuit 6 according to the second embodiment of the present invention. The following describes the point of the present embodiment different from that of the first embodiment. In FIG. 10, the diodes Dsu1 and Dsu2 illustrated in FIG. 4 are removed and diodes Dsd1 and Dsd2 are added instead.

A series connection circuit of a switching element Ssd1 and a diode Dsd1 forms switching means and is connected between the X electrode Xi and the terminal of the ground potential GND. The switching element Ssd1 is, for example, an n-channel field effect transistor. The transistor Ssd1 includes a parasitic diode, the gate of the transistor Ssd1 is connected to a voltage CD1, the drain thereof is connected to the side of the X electrode Xi and the source thereof is connected to the side of the terminal of the ground potential GND. The anode of the parasitic diode is connected to the source of the transistor Ssd1 and the cathode thereof is connected to the drain of the transistor Ssd1. The cathode of the diode Dsd1 is connected to the side of the terminal of the ground potential GND and the anode thereof is connected to the side of the X electrode Xi.

A switching element Ssu1 forms switching means and is connected between the X electrode Xi and the terminal of the power supply voltage Vs. The switching element Ssu1 is, for example, an n-channel field effect transistor. The transistor Ssu1 includes a parasitic diode, the gate of the transistor Ssu1 is connected to a voltage CU1, the source thereof is connected to the X electrode Xi and the drain thereof is connected to the terminal of the power supply voltage Vs. The anode of the parasitic diode is connected to the source of the transistor Ssu1 and the cathode thereof is connected to the drain of the transistor Ssu1.

A series connection circuit of a switching element Ssd2 and a diode Dsd2 forms switching means and is connected between the Y electrode Yi and the terminal of the ground potential GND. The switching element Ssd2 is, for example, an n-channel field effect transistor. The transistor Ssd2 includes a parasitic diode, the gate of the transistor Ssd2 is connected to a voltage CD2, the drain thereof is connected to the side of the Y electrode Yi and the source thereof is connected to the side of terminal of the ground potential GND. The anode of the parasitic diode is connected to the source of the transistor Ssd2 and the cathode thereof is connected to the drain of the transistor Ssd2. The cathode of the diode Dsd2 is connected to the side of the terminal of the ground potential GND and the anode thereof is connected to the side of the Y electrode Yi.

A switching element Ssu2 forms switching means and is connected between the Y electrode Yi and the terminal of the power supply voltage Vs. The switching element Ssu2 is, for example, an n-channel field effect transistor. The transistor Ssu2 includes a parasitic diode, the gate of the transistor Ssu2 is connected to a voltage CU2, the source thereof is connected to the Y electrode Yi and the drain thereof is connected to the terminal of the power supply voltage Vs. The anode of the parasitic diode is connected to the source of the transistor Ssu2 and the cathode thereof is connected to the drain of the transistor Ssu2.

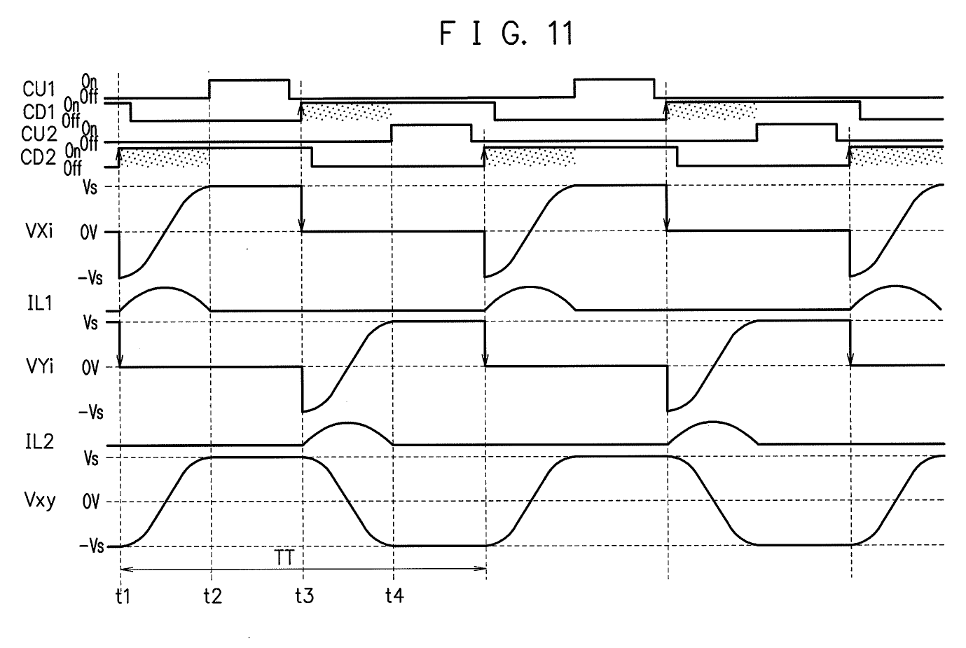

FIG. 11 is a timing chart illustrating a method for driving the X and the Y electrode driving circuit in FIG. 10 and describes the operation of the sustain period Ts in FIG. 3. A voltage VXi denotes a voltage that appears at the X electrode Xi. A current IL1 indicates a current flowing into the coil L1. A voltage VYi denotes a voltage that appears at the Y electrode Yi. A current IL2 indicates a current flowing into the coil L2. A voltage Vxy is a voltage that appears between the X electrode Xi and the Y electrode Yi and is expressed by the voltages VXi-XYi.

Prior to a time t1, the voltage VXi is set to 0 [V] and the voltage VYi are set to the power supply voltage Vs [V] as described later in detail.

At a time t1, the voltages CD1 and CD2 are rendered to be in a high level state and the voltages CU1 and CU2 are rendered to be in a low level state. This turns on the transistors Ssd1 and Ssd2 and turns off the transistors Ssu1 and Ssu2. As a result, the voltage VYi lowers to 0 [V] and the voltage VXi also lowers to −Vs [V].

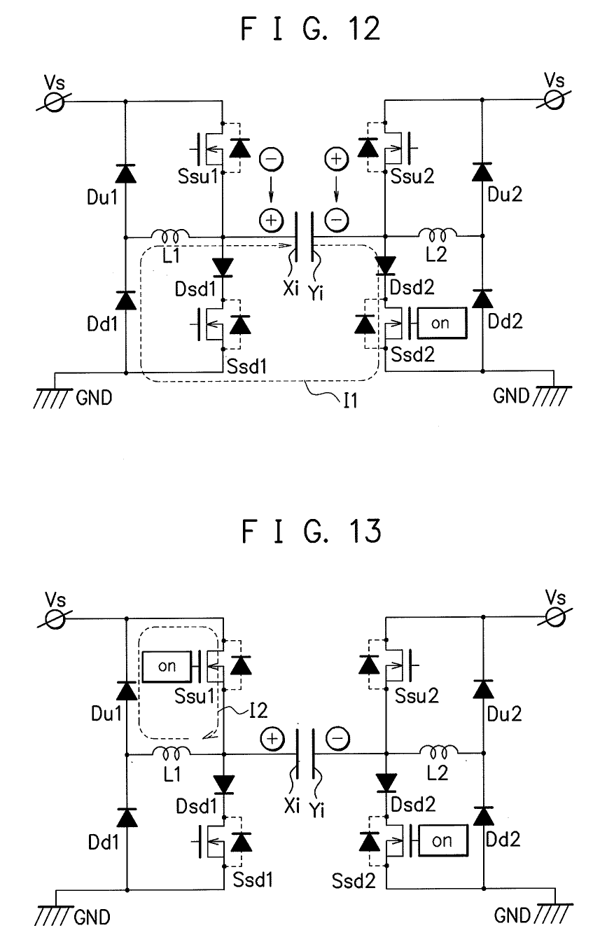

After that, the voltage CD1 is rendered to be in a low level state. Then, the transistor Ssd2 is turned on, the transistors Ssu1, Ssd1 and Ssu2 are turned off and a current I1 flows through the terminal of the ground potential GND as illustrated in FIG. 12. The coil current IL1 flows and the voltage VXi increases from −Vs [V] to +Vs [V] due to LC resonance between the capacitance Cp and the coil L1.

At a time t2, the voltage CU1 is rendered to be in a high level state. This turns on the transistors Ssu1 and Ssd2 and turns off the transistors Ssu2 and Ssd1 to cause a current I2 to flow as illustrated in FIG. 13. The voltage VXi is fixed to Vs [V]. Thereafter, the voltage CU1 is rendered to be in a low level state to turn off the transistor Ssu1.

At a time t3, the voltage CD1 is rendered to be in a high level state. This turns on the transistors Ssd1 and Ssd2 and turns off the transistors Ssu1 and Ssu2. As a result, the voltage VXi lowers to 0 [V] and the voltage VYi also lowers to −Vs [V].

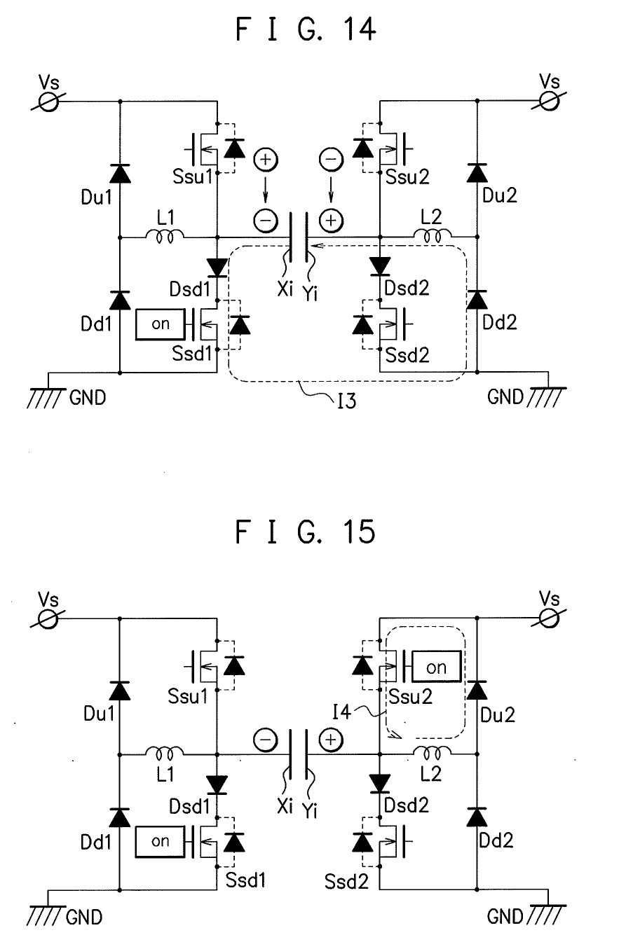

After that, the voltage CD2 is rendered to be in a low level state. This turns on the transistor Ssd1 and turns off the transistors Ssu1, Ssu2 and Ssd2 to cause a current I3 to flow through the terminal of the ground potential GND as illustrated in FIG. 14. The coil current IL2 flows and the voltage VYi increases from −Vs [V] to +Vs [V] due to LC resonance between the capacitance Cp and the coil L2.

At a time t4, the voltage CU2 is rendered to be in a high level state. This turns on the transistors Ssu2 and Ssd1 and turns off the transistors Ssu1 and Ssd2 to cause a current I4 to flow as illustrated in FIG. 15. The voltage VYi is fixed to Vs [V]. Thereafter, the voltage CU2 is rendered to be in a low level state to turn off the transistor Ssu2.

After that, returning to a time t1, the operation of a period TT is repeated. Electrical discharge is caused between the X electrode Xi and the Y electrode Yi at points when the voltage Vxy increases from 0 [V] to about Vs [V] and decreases from 0 [V] to about −Vs [V].

As described above, a first switching means (transistor) Ssd1 is connected between a first electrode (X electrode) Xi and a first potential (ground potential) GND. A second switching means (transistor) Ssu1 is connected between the first electrode Xi and the terminal of a second potential (power supply voltage) Vs. A third switching means (transistor) Ssd2 is connected between a second electrode (Y electrode) Yi and the first potential (ground potential) GND. A fourth switching means (transistor) Ssu2 is connected between the second electrode Yi and the second potential terminal Vs.

At a first step at a time t2, the first switching means (transistor) Ssd1 and the fourth switching means (transistor) Ssu2 are turned off and the second switching means (transistor) Ssu1 and the third switching means (transistor) Ssd2 are turned on. At the first step, the voltage VXi at the first electrode (X electrode) Xi becomes the second potential (power supply voltage) Vs. The voltage VYi at the second electrode (Y electrode) Yi becomes the first potential (ground potential) GND.

At a second step before a time t4 following the first step, the first switching means Ssd1 is turned on and the second, the third and the fourth switching means Ssu1, Ssd2 and Ssu2 are turned off. At the second step, the voltage VXi at the first electrode Xi becomes the first potential GND and the voltage VYi at the second electrode Yi changes by a differential potential −Vs between the first potential GND and the second potential Vs and changes to the second potential Vs due to LC resonance thereafter.

At the third step at a time t4 following the second step, the first and the fourth switching means Ssd1 and Ssu2 are turned on and the second and the third switching means Ssu1 and Ssd2 are turned off. At the third step, the voltage VXi at the first electrode Xi becomes the first potential GND and the voltage VYi at the second electrode Yi becomes the second potential Vs.

As is the case with the first embodiment, in the transistors Ssd1 and Ssd2, current always flows from the drain to source. For this reason, the transistors Ssd1 and Ssd2 do not require parasitic diodes. The IGBT may be used as the transistors Ssd1 and Ssd2 instead of field effect transistors.

As is the case with the transistors Ssd1 and Ssd2, the transistors Ssu1 and Ssu2 do not require parasitic diodes because current always flows from the drain to source therein. The IGBT may be used as the transistors Ssu1 and Ssu2 instead of field effect transistors.

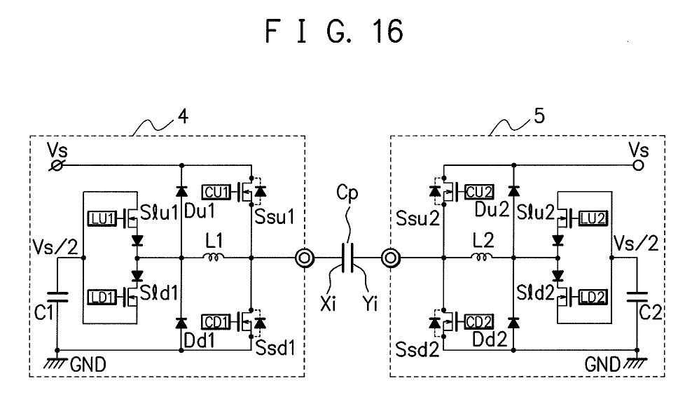

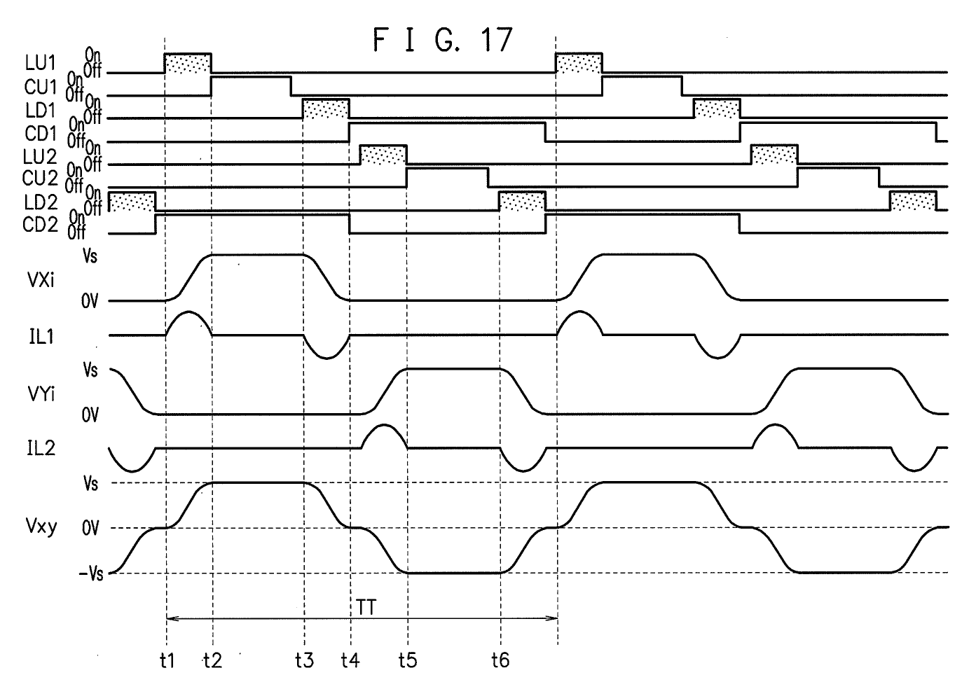

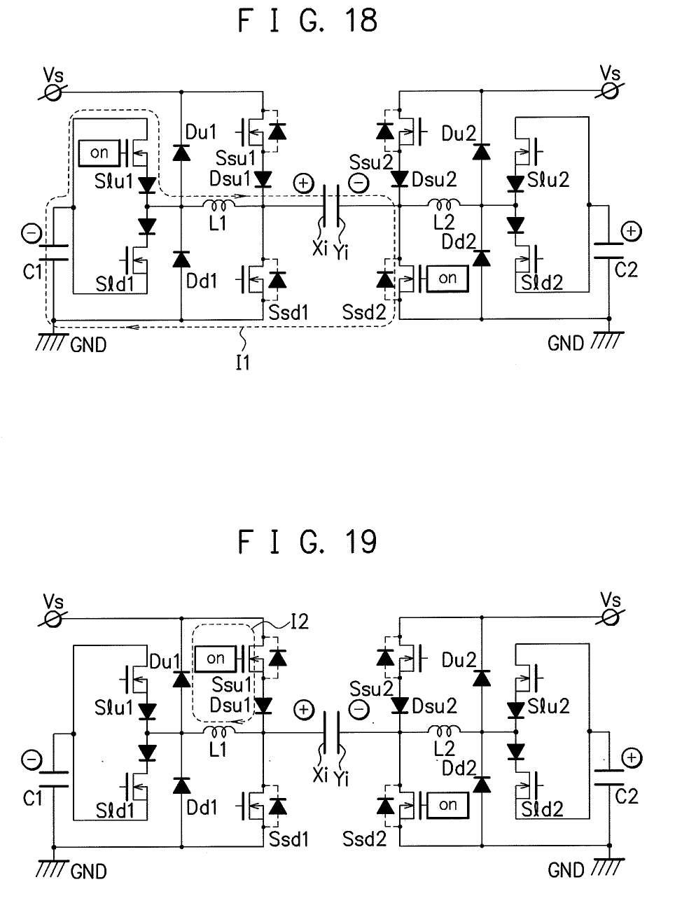

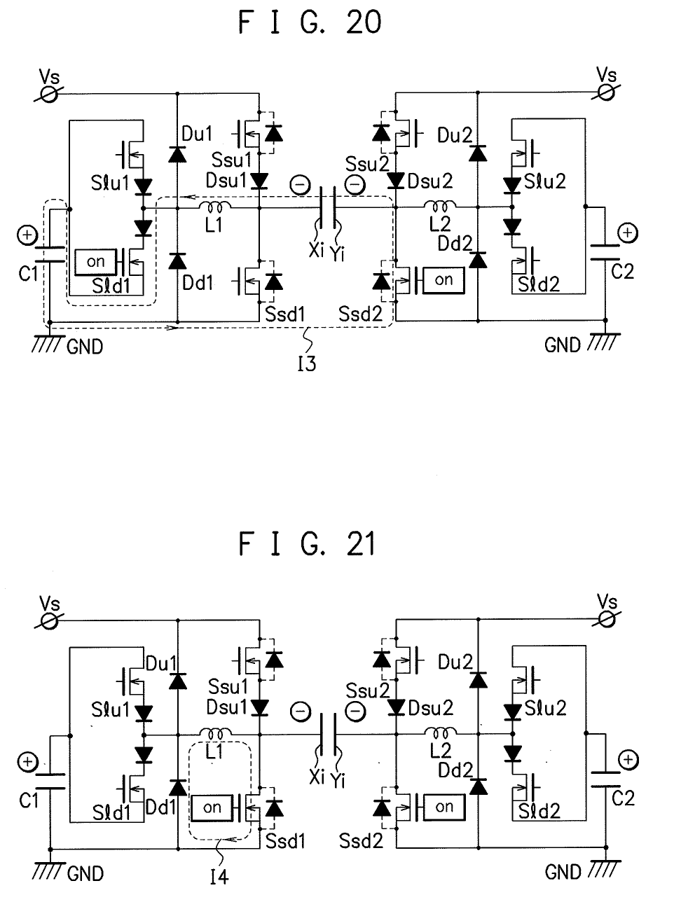

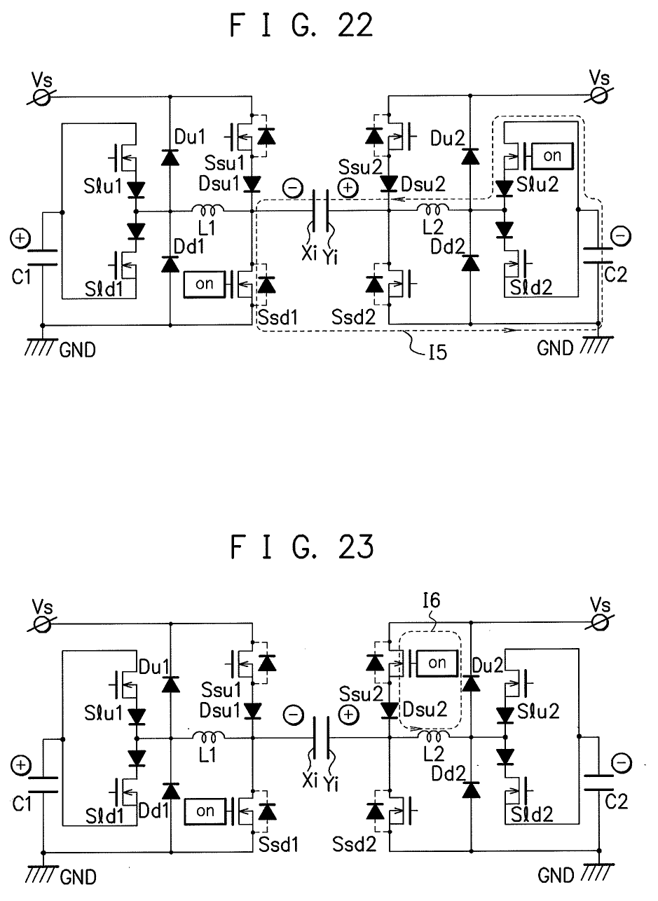

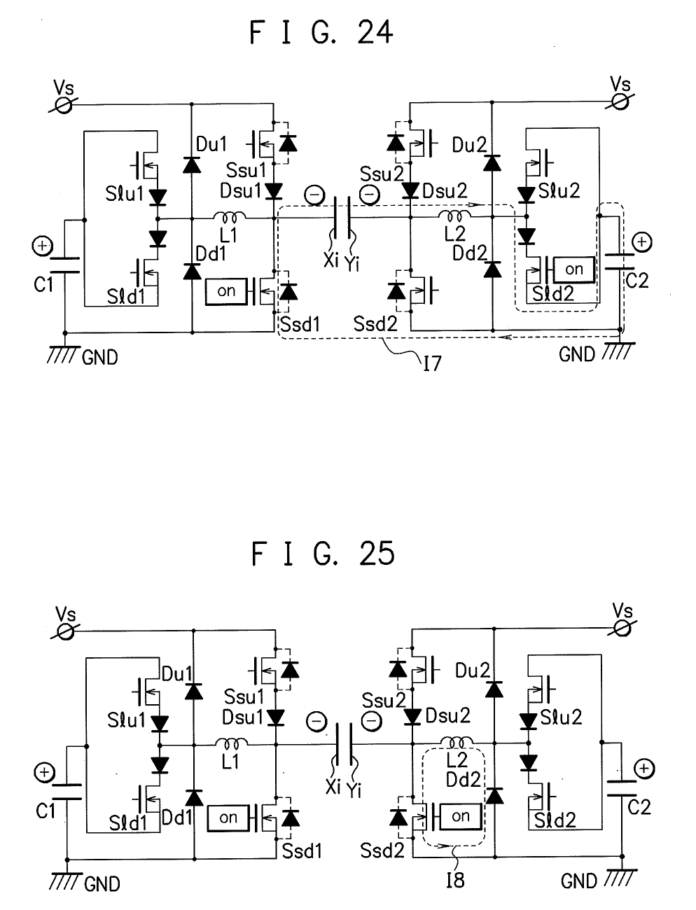

The plasma display device in FIG. 16 requires the transistors Slu1, Sld1, Slu2 and Sld2 for starting a series resonance and the capacitances C1 and C2 for transferring the charge of the capacitance Cp, which leads to a drawback in that circuit elements are increased in number. On the other hand, the plasma display device according to the first and the second embodiments of the present invention uses the transistors Ssu1, Ssu2, Ssd1 or Ssd2 as switching elements both for voltage clamp and for an LC resonance circuit, so that the above circuit elements are not required, enabling reduction in the circuit elements. As a result, the cost can be reduced.

The plasma display device in FIG. 16 requires a pause period during which the voltage Vxy becomes 0 V between the LC resonance at the voltage VXi and that at the voltage VYi, which raises a drawback in that the period TT is increased. On the other hand, the plasma display device according to the first and the second embodiments of the present invention does not require a pause period during which the voltage Vxy becomes 0 V, allowing the period TT to be shortened. This enables increasing the number of sustain pulses to enhance the luminance of the plasma display device.

The plasma display device in FIG. 16 has a drawback in that switching for the LC resonance needs to be performed as many as four times in one period TT. On the other hand, the plasma display device according to the first and the second embodiments of the present invention requires switching for LC resonance as few as two times in one period TT. As a result, the control of switching is simplified and restraint of timing is reduced to allow a stable sustain discharge.

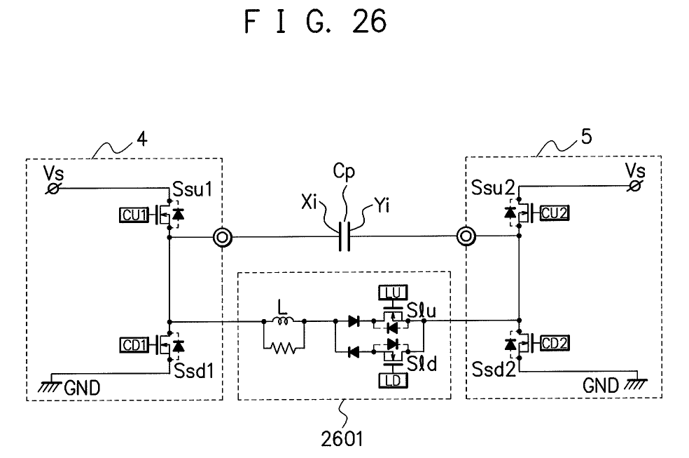

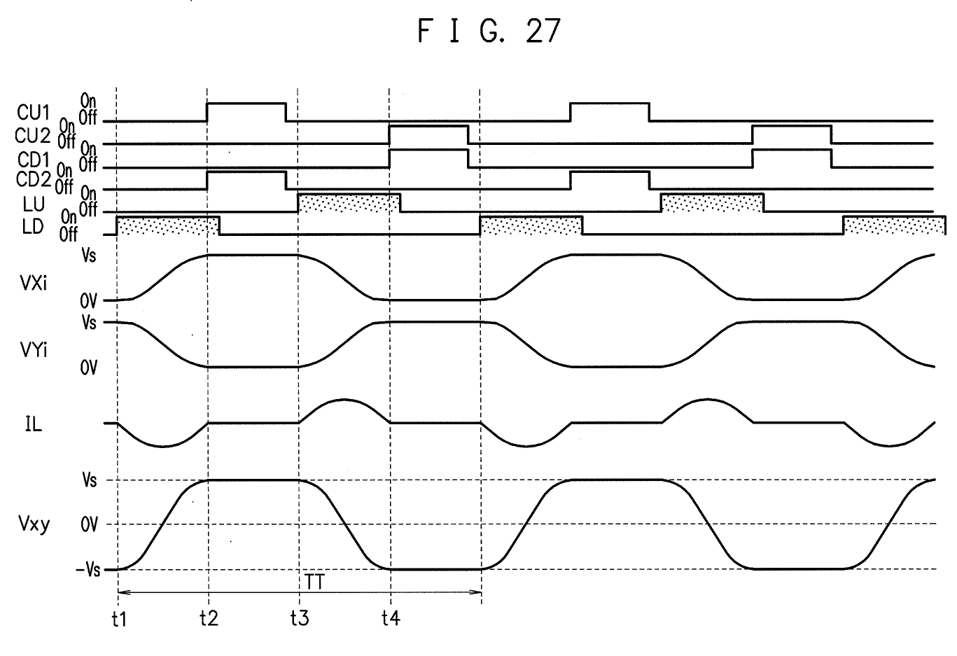

The plasma display device in FIG. 26 requires the transistors Slu and Sld for starting a parallel resonance, which leads to a drawback in that circuit elements are increased in number. On the other hand, the plasma display device according to the first and the second embodiments of the present invention does not require the above circuit elements to enable the circuit elements to be reduced. As a result, the cost can be reduced.

The plasma display device in FIG. 26 has a drawback in that the charging and discharging circuit unit 2601 is required including a path into which a resonance current flows between the driving circuits 4 and 5. On the other hand, the plasma display device according to the first and the second embodiments of the present invention does not require the charging and discharging circuit unit 2601 including a path into which a resonance current flows because a parallel resonance current is caused to flow through the terminals of the power supply voltage Vs and the ground potential GND. As a result, a special wiring for the resonance current path is not required, enabling the cost to be reduced.

It should be understood that the foregoing embodiments relate to only practical examples in carrying out the present invention, so that these are not to be construed as limiting the technical scope of the present invention. The present invention may be embodied in various forms without departing from the spirit and chief advantages of the invention.

An LC resonance current flowing through a first and second potential terminal enables the number of circuit elements to be reduced and the cost to be reduced. Decreasing the number of times of LC resonance allows simplifying the control of first to fourth switching means and shortening the voltage period of the first and the second electrode. This permits increasing the number of times of discharge per unit time and increasing luminance.

What is claimed is:

1. A method for driving a plasma display device comprising:
a first and a second discharging electrode;
a first coil connected to the first electrode;
a second coil connected to the second electrode;
a first potential terminal to which a first potential is supplied;
a second potential terminal to which a second potential different from the first potential is supplied;
first switching means connected between the first electrode and the first potential terminal;
second switching means connected between the first electrode and the second potential terminal;
third switching means connected between the second electrode and the first potential terminal;
fourth switching means connected between the second electrode and the second potential terminal;
a first diode connected between the first electrode through the first coil and the first potential terminal;
a second diode connected between the first electrode through the first coil and the second potential terminal;
a third diode connected between the second electrode through the second coil and the first potential terminal; and
a fourth diode connected between the second electrode through the second coil and the second potential terminal;
the method comprising:
a first step of turning off the first and fourth switching means and turning on the second and the third switching means;
a second step of turning on the first switching means and turning off the second to the fourth switching means after the first step; and
a third step of turning on the first and the fourth switching means and turning off the second and the third switching means after the second step.

2. The method for driving a plasma display device according to claim 1, wherein
at the first step, an potential at the first electrode becomes the second potential and an potential at the second electrode becomes the first potential,
at the second step, an potential at the first electrode becomes the first potential and an potential at the second electrode changes by a differential potential between the first and the second potential and thereafter changes to the second potential due to LC resonance, and
at the third step, the potential at the first electrode becomes the first potential and the potential at the second electrode becomes the second potential.

3. The method for driving a plasma display device according to claim 1, wherein
the first switching means includes a series connection circuit of a first switching element and a fifth diode, and
the third switching means includes a series connection circuit of a second switching element and a sixth diode.

4. The method for driving a plasma display device according to claim 3, wherein
the first and the second switching element are IGBT.

5. The method for driving a plasma display device according to claim 3, wherein
the first potential is higher than the second potential,
the anode of the first diode is connected to the first electrode through the first coil and the cathode thereof is connected to the first potential terminal,
the cathode of the second diode is connected to the first electrode through the first coil and the anode thereof is connected to the second potential terminal,
the anode of the third diode is connected to the second electrode through the second coil and the cathode thereof is connected to the first potential terminal,
the cathode of the fourth diode is connected to the second electrode through the second coil and the anode thereof is connected to the second potential terminal,
the anode of the fifth diode is connected to the side of terminal of the first potential and the cathode thereof is connected to the side of the first electrode, and
the anode of the sixth diode is connected to the side of terminal of the first potential and the cathode thereof is connected to the side of the second electrode.

6. The method for driving a plasma display device according to claim 3, wherein
the first potential is lower than the second potential,
the cathode of the first diode is connected to the first electrode through the first coil and the anode thereof is connected to the first potential terminal,
the anode of the second diode is connected to the first electrode through the first coil and the cathode thereof is connected to the second potential terminal,
the cathode of the third diode is connected to the second electrode through the second coil and the anode thereof is connected to the first potential terminal,
the anode of the fourth diode is connected to the second electrode through the second coil and the cathode thereof is connected to the second potential terminal,
the cathode of the fifth diode is connected to the side of terminal of the first potential and the anode thereof is connected to the side of the first electrode, and
the cathode of the sixth diode is connected to the side of terminal of the first potential and the anode thereof is connected to the side of the second electrode.

7. The method for driving a plasma display device according to claim 1, wherein
the plasma display device comprises a third electrode discharging into the first and the second electrode and switching means causing the third electrode to be electrically higher in resistance than a power supply at the first to the third step.

8. A plasma display device comprising:
a first and a second discharging electrode;
a first coil connected to the first electrode;
a second coil connected to the second electrode;
a first potential terminal to which a first potential is supplied;
a second potential terminal to which a second potential different from the first potential is supplied;
first switching means connected between the first electrode and the first potential terminal;
second switching means connected between the first electrode and the second potential terminal;
third switching means connected between the second electrode and the first potential terminal;
fourth switching means connected between the second electrode and the second potential terminal;
a first diode connected between the first electrode through the first coil and the first potential terminal;
a second diode connected between the first electrode through the first coil and the second potential terminal;
a third diode connected between the second electrode through the second coil and the first potential terminal;
a fourth diode connected between the second electrode through the second coil and the second potential terminal; and
a driving circuit performing a first step of turning off the first and fourth switching means and turning on the second and the third switching means, a second step of turning on the first switching means and turning off the second to the fourth switching means after the first step and a third step of turning on the first and the fourth switching means and turning off the second and the third switching means after the second step.

9. The plasma display device according to claim 8, wherein
at the first step, an potential at the first electrode becomes the second potential and an potential at the second electrode becomes the first potential,
at the second step, an potential at the first electrode becomes the first potential and an potential at the second electrode changes by a differential potential between the first and the second potential and thereafter changes to the second potential due to LC resonance, and
at the third step, the potential at the first electrode becomes the first potential and the potential at the second electrode becomes the second potential.

10. The plasma display device according to claim 8, wherein
the first switching means includes a series connection circuit of a first switching element and a fifth diode, and
the third switching means includes a series connection circuit of a second switching element and a sixth diode.

11. The plasma display device according to claim 10, wherein
the first and the second switching element are IGBT.

12. The plasma display device according to claim 10, wherein
the first potential is higher than the second potential,
the anode of the first diode is connected to the first electrode through the first coil and the cathode thereof is connected to the first potential terminal,
the cathode of the second diode is connected to the first electrode through the first coil and the anode thereof is connected to the second potential terminal,
the anode of the third diode is connected to the second electrode through the second coil and the cathode thereof is connected to the first potential terminal,
the cathode of the fourth diode is connected to the second electrode through the second coil and the anode thereof is connected to the second potential terminal,
the anode of the fifth diode is connected to the side of terminal of the first potential and the cathode thereof is connected to the side of the first electrode, and
the anode of the sixth diode is connected to the side of terminal of the first potential and the cathode thereof is connected to the side of the second electrode.

13. The plasma display device according to claim 10, wherein
the first potential is lower than the second potential,
the cathode of the first diode is connected to the first electrode through the first coil and the anode thereof is connected to the first potential terminal,
the anode of the second diode is connected to the first electrode through the first coil and the cathode thereof is connected to the second potential terminal,
the cathode of the third diode is connected to the second electrode through the second coil and the anode thereof is connected to the first potential terminal,
the anode of the fourth diode is connected to the second electrode through the second coil and the cathode thereof is connected to the second potential terminal,
the cathode of the fifth diode is connected to the side of terminal of the first potential and the anode thereof is connected to the side of the first electrode, and
the cathode of the sixth diode is connected to the side of terminal of the first potential and the anode thereof is connected to the side of the second electrode.

14. The plasma display device according to claim 8 further comprises a third electrode discharging into the first and the second electrode and switching means causing the third electrode to be electrically higher in resistance than a power supply at the first to the third step of the driving circuit.
